(19) United States
(12) Patent Application Publication
(10) Pub. No.: US 2013/0066584 A1
(43) Pub. Date: Mar. 14, 2013

(54) TEMPERATURE ESTIMATION METHOD, TEMPERATURE ESTIMATION APPARATUS, AND PROGRAM THEREOF

(71) Applicants: Li Lan, Singapore (SG); Shu Feng Fan, Singapore (SG); Kok Seng Chong, Singapore (SG); Anh Tuan Tran, Singapore (SG); Satoshi Kondo, Kyoto (JP)

(72) Inventors: Li Lan, Singapore (SG); Shu Feng Fan, Singapore (SG); Kok Seng Chong, Singapore (SG); Anh Tuan Tran, Singapore (SG); Satoshi Kondo, Kyoto (JP)

(21) Appl. No.: 13/698,823

(22) PCT Filed: Apr. 3, 2012
(86) PCT No.: PCT/JP2012/002326

§ 371 Date: Nov. 19, 2012

(30) Foreign Application Priority Data
Apr. 7, 2011 (JP) 2011-085719

(51) Int. Cl. G01K 11/22; G06F 15/00

(52) U.S. Cl. 702/130; 374/119; 374/E11.009

(57) ABSTRACT

A temperature estimation method including: receiving a scan signal generated by scanning the target region using the ultrasound signal, and estimating, based on the scan signal, an echo shift which is an amount of change in time required for the ultrasound signal to pass through the target region, the time changing depending on the temperature in the target region; estimating, based on the estimated echo shift, a strain which is an apparent change rate of a travel distance required for the ultrasound signal to pass through the target region, the travel distance changing depending on the temperature in the target region; estimating, based on the estimated strain, a strain rate which is a temporal change rate of the strain; and estimating the temperature in the target region corresponding to the strain and the strain rate, based on a predetermined relationship between a strain, a strain rate, and a temperature.

### TECHNICAL FIELD

The present invention relates to a temperature estimation method and a temperature estimation apparatus for estimating, for example, a temperature in a given area of a living subject, and a program thereof.

### BACKGROUND ART

Recently, HIFU treatments using high intensity focused ultrasounds (HIFU) have been performed. The HIFU treatments are intended to necrotize a treatment target area by focusing a strong ultrasound signal on the treatment target area such as a tumor via the body surface of a patient until the temperature in the treatment target area reaches a predetermined temperature (for example, in a range from 80 to 90 degrees Celsius). From a viewpoint of performing a reliable treatment, the HIFU treatment requires estimation of the temperature in the treatment target area to check that the temperature in the treatment target area has risen up to the predetermined temperature. Furthermore, from a viewpoint of securing safety, the HIFU treatment requires estimation of the temperature in a region surrounding the treatment target region to check that the temperature in the surrounding area has not risen excessively.

Exemplary methods for estimating temperatures in the treatment target area etc. in this way include temperature estimation methods using ultrasound signals (for example, see Patent Literatures 1 to 3 and Non-Patent Literatures 1 and 2).

### CITATION LIST

### Patent Literature

### [PTL 1]

U.S. Pat. No. 4,452,081, Specification

### [PTL 2]

U.S. Pat. No. 7,211,044, Specification

### [PTL 3]

United States Patent Application Publication No. 2007/0106157, Specification

### Non Patent Literature

### [NPL 1]

Miller, N. R., J. C. Bamber, and P. M. Meaney, Fundamental limitations of noninvasive temperature imaging by means of ultrasound echo strain estimation, Ultrasound in medicine & biology, 2002.28(10): p. 1319

### [NPL 2]

Valvano, J. W., Bioheat transfer, in Encyclopedia of Medical Devices and Instrumentation, 2005, Wiley

### SUMMARY OF INVENTION

### Technical Problem

However, the conventional temperature estimation methods using ultrasound signals do not enable accurate temperature estimation, and can only estimate temperatures in narrow temperature ranges.

The present invention has been made to solve the aforementioned conventional problems with an aim to provide a temperature estimation method, a temperature estimation apparatus, and a program thereof which enable accurate temperature estimation in wide temperature ranges.

### Solution to Problem

In order to achieve the aim, a temperature estimation method according to an aspect of the present invention is a temperature estimation method of estimating a temperature in a target region using an ultrasound signal, the temperature estimation method including: receiving a scan signal generated by scanning the target region using the ultrasound signal, and estimating, based on the scan signal, an echo shift which is an amount of change in time required for the ultrasound signal to pass through the target region, the time changing depending on the temperature in the target region; estimating, based on the estimated echo shift, a strain which is an apparent change rate of a travel distance required for the ultrasound signal to pass through the target region, the travel distance changing depending on the temperature in the target region; estimating, based on the estimated strain, a strain rate which is a temporal change rate of the strain; and estimating the temperature in the target region corresponding to the strain and the strain rate, based on a predetermined relationship between a strain, a strain rate, and a temperature.

It is to be noted that the present invention can be realized not only as a method, but also as an apparatus having processing units which perform the steps of the method, a program for causing a computer to execute the steps, a recording medium such as a computer-readable CD-ROM having the program recorded thereon, and/or information, data, or a signal representing the program. These program, information, data, and signal may be distributed via communication networks such as the Internet.

### Advantageous Effects of Invention

A temperature estimation method according to the present invention makes it possible to estimate a temperature with a high accuracy in a wide temperature range by estimating the temperature in a target region corresponding to a strain and a strain rate estimated based on a predetermined relationship between a strain, a strain rate, and a temperature.

### BRIEF DESCRIPTION OF DRAWINGS

FIG. 1 is a block diagram of a structure of a temperature estimation apparatus according to Embodiment 1 of the present invention.

FIG. 2 is a diagram for illustrating a scan signal.

FIG. 3 is a block diagram of a specific structure of a signal processing unit in FIG. 1.

FIG. 4 is a block diagram of a specific structure of a pre-processing unit.

FIG. 5 is a diagram showing corrupted frames generated in a scan signal.

FIG. 6 is a block diagram of a specific structure of an echo shift estimating unit.

FIG. 7 is a diagram for illustrating an echo shift calculating step.

FIG. 8 is a diagram for illustrating an outlier correcting step.

FIG. 9 is a block diagram of a specific structure of a strain estimating unit.

FIG. 10 is a block diagram of a specific structure of a strain rate estimating unit.

FIG. 11 is a block diagram of a specific structure of a temperature estimating unit.

FIG. 12 is a flowchart of temperature estimation using a temperature estimation method according to Embodiment 1 of the present invention.

FIG. 13 is a diagram for illustrating a temperature estimating step.

FIG. 14 is a diagram showing results of a trial using a temperature estimation method according to the present invention and a comparison trial using a conventional temperature estimation method.

FIG. 15 is a diagram showing results of a trial using a temperature estimation method according to the present invention and a comparison trial using a conventional temperature estimation method.

FIG. 16 is a block diagram of a structure of a temperature estimation apparatus according to Embodiment 2 of the present invention.

FIG. 17 is a block diagram of a structure of a temperature estimation apparatus according to Embodiment 3 of the present invention.

FIG. 18 is a diagram showing a model relationship between model temperatures and strains in a conventional temperature estimation method.

### DESCRIPTION OF EMBODIMENTS

### Underlying Knowledge Forming Basis of the Present Invention

The Inventors have found a problem in a conventional temperature estimation method, and thus mention the problem before explaining embodiments of the present invention.

### (Conventional Temperature Estimation Method 1)

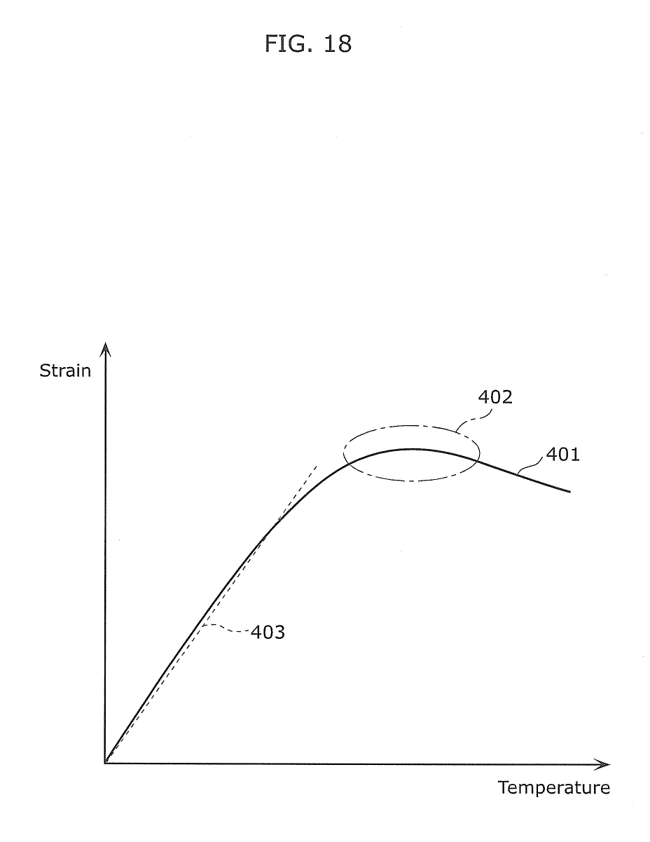

FIG. 18 is a diagram showing a model relationship between temperatures and strains in a conventional temperature estimation method. The conventional temperature estimation method 1 estimates a temperature in a treatment target area etc. utilizing a fact that the speed of an ultrasound signal changes depending on the temperature. For example, the speed of the ultrasound signal for temperature estimation changes with change in the temperature in the treatment target area before and after an HIFU treatment is performed by focusing an ultrasound signal for heating on the treatment target area. The change in the speed of the ultrasound signal causes an apparent change in the travel distance through which the ultrasound signal passes through the treatment target area. The travel distance change rate is referred to as a strain.

The conventional temperature estimation method 1 calculates a strain based on the difference between an ultrasound signal before a treatment and an ultrasound signal during the treatment, and then estimates temperatures according to a model equation showing the relationship between the temperatures and the strains. This model equation is an approximate quadratic function as shown by the solid line 401 in the graph of FIG. 18.

However, as shown in FIG. 18, the aforementioned model equation includes a frat range 402 that is a region in which strain change with respect to temperature change is small and in which noise influence is large. For this reason, the conventional temperature estimation method 1 does not enable accurate temperature estimation.

### (Conventional Temperature Estimation Method 2)

Similarly, the conventional temperature estimation method 2 calculates a strain based on the difference between an ultrasound signal before a treatment and an ultrasound signal during the treatment, and then estimates a temperature according to a model equation showing the relationship between the temperatures and the strains. This model equation is an approximate linear function as shown by the broken line 403 in the graph of FIG. 18.

However, the aforementioned model equation enables temperature estimation only in a comparatively low temperature range (approximately from 30 to 50 degrees Celsius). It is difficult to use this conventional temperature estimation method 2 for temperature estimation in an HIFU treatment that requires temperature estimation in a comparatively high temperature range (approximately from 70 to 90 degrees Celsius).

### (Conventional Temperature Estimation Method 3)

The conventional temperature estimation method 3 employs a bio-heat transfer equation as a model equation. First, parameters in the model equation are calculated at the time of calibration, and the relational equation showing the relationship between temperatures and strains is obtained. For example, in an HIFU treatment, a temperature in a treatment target area is estimated according to the model equation. Then, a strain is calculated based on the estimated temperature according to the relational equation, and the parameters in the model equation are sequentially corrected to minimize the error between the calculated strain and the strain obtained from an radio frequency (RF) signal.

However, the conventional temperature estimation method 3 requires complicated calculations for obtaining the parameters in the model equation, and thus is difficult to be realized for practical use.

In order to solve the aforementioned problem, a temperature estimation method according to an aspect of the present invention is a temperature estimation method of estimating a temperature in a target region using an ultrasound signal, and the temperature estimation method includes: receiving a scan signal generated by scanning the target region using the ultrasound signal, and estimating, based on the scan signal, an echo shift which is an amount of change in time required for the ultrasound signal to pass through the target region, the time changing depending on the temperature in the target region; estimating, based on the estimated echo shift, a strain which is an apparent change rate of a travel distance required for the ultrasound signal to pass through the target region, the travel distance changing depending on the temperature in the target region; estimating, based on the estimated strain, a strain rate which is a temporal change rate of the strain; and estimating the temperature in the target region corresponding to the strain and the strain rate, based on a predetermined relationship between a strain, a strain rate, and a temperature.

According to this aspect, it is possible to estimate the temperature with a high accuracy in a wide temperature range.

For example, in the estimating of a temperature in the temperature estimation method according to the aspect of the present invention, the temperature in the target region corresponding to the strain and the strain rate may be estimated according to a linear model equation showing the relationship between the strain, the strain rate, and the temperature.

According to this aspect, it is possible to predict the temperature using the linear model equation showing the relationship between the strain, the strain rate, and the temperature.

For example, in the temperature estimation method according to the aspect of the present invention may further include removing, as pre-processing, a frame corrupted by disturbance from the scan signal, wherein, in the estimating of an echo shift, the echo shift may estimated based on the scan signal from which the corrupted frame is already removed in the removing.

According to this aspect, it is possible to remove the corrupted frame generated in the scan signal, as the pre-processing performed before estimating the echo shift.

For example, in the temperature estimation method according to the aspect of the present invention, the estimating of an echo shift may further include: calculating a raw echo shift based on the received scan signal; correcting an outlier that is not caused by a temperature change in the calculated raw echo shift to generate an echo shift that is caused by a temperature change; and attenuating, using a noise filter, noise included in the echo shift caused by the temperature change.

According to this aspect, it is possible to generate the echo shift caused by the temperature change, by correcting the outlier that is not caused by the temperature change in the calculated raw echo shift.

For example, in the temperature estimation method according to the aspect of the present invention, the correcting of an outlier may include: adjusting a parameter in an echo shift prediction model for calculating a predicted echo shift, based on the raw echo shift calculated in the calculating of an echo shift; calculating the predicted echo shift based on the echo shift prediction model that is optimized; setting one or more threshold values, based on the predicted echo shift and an RF signal that is generated by scanning the target region; and correcting a data point that is included in a plurality of data points of the raw echo shift and is the outlier exceeding the one or more threshold values to fit a data point corresponding to the predicted echo shift.

According to this aspect, it is possible to detect the outlier.

For example, in the temperature estimation method according to the aspect of the present invention, the echo shift prediction model may be an error function or a complementary error function.

According to this aspect, it is possible to make the echo shift prediction model as the error function or the complementary error function.

For example, in the temperature estimation method according to the aspect of the present invention, the setting of a threshold value may include: setting a gap between an upper threshold value and a lower threshold value as the one or more threshold values; and adjusting the upper threshold value and the lower threshold value by using, as a weight, intensity of the RF signal.

According to this aspect, it is possible to set the threshold value for detecting the outlier.

For example, in the estimating of a strain rate in the temperature estimation method according to the aspect of the present invention, the strain rate may be estimated using a model equation for predicting the echo shift based on a depth and a product of the depth and time of the scan signal in such a manner that an error between the echo shift estimated based on the scan signal and the echo shift predicted according to the model equation is minimized.

According to this aspect, it is possible to estimate the strain rate.

For example, in the temperature estimation method according to the aspect of the present invention, the model equation used in the estimating of a strain rate may be a linear model equation.

According to this aspect, it is possible to make the model equation used in the estimating of a strain rate as a linear model equation.

For example, in the temperature estimation method according to the aspect of the present invention, an algorithm parameter in the linear model equation used in the estimating of a temperature may be identified by: aligning a thermocouple with the target region to be heated; measuring the temperature in the target region using the thermocouple; deriving the estimated temperature in the target region, based on the scan signal generated by scanning the target region; and identifying the algorithm parameter that minimizes an error between the temperature measured in the measuring of the temperature and the estimated temperature derived in the deriving of the estimated temperature.

According to this aspect, it is possible to identify the algorithm parameter in the linear model equation used in the estimating of a temperature.

For example, in the temperature estimation method according to the aspect of the present invention, the aligning may include: aligning the thermocouple with the target region to be heated, using a B-mode image; turning ON a heat source that outputs an ultrasound signal to change the temperature in the target region; performing iterations of (i) shifting the heat source in a space and (ii) measuring a temperature in the target region using the thermocouple; and stopping the shifting of the heat source when a temperature measured using the thermocouple reaches a minimum.

According to this aspect, it is possible to align the thermocouple with the target region to be heated.

For example, the temperature estimation method according to the aspect of the present invention may further include correcting the temperature estimated in the estimating of a temperature, based on an objective function considering spatial continuity of temperatures.

According to this aspect, it is possible to correct the temperature estimated in the estimating of a temperature, considering the spatial continuity of the temperatures.

For example, the temperature estimation method according to the aspect of the present invention may further include correcting the temperature estimated in the estimating of a temperature, based on an objective function considering a distance between the target region and a position of a body area heated by an ultrasound signal for heating.

According to this aspect, it is possible to correct the temperature estimated in the estimating of a temperature, considering the distance between the target region and the position of the body area heated by the ultrasound signal for heating (such as HIFU).

A temperature estimation apparatus according to an aspect of the present invention is a temperature estimation device which estimates a temperature in a target region using an ultrasound signal, and the temperature estimation apparatus includes: receiving a scan signal generated by scanning the target region using the ultrasound signal, and estimating, based on the scan signal, an echo shift which is an amount of change in time required for the ultrasound signal to pass through the target region, the time changing depending on the temperature in the target region; estimating, based on the estimated echo shift, a strain which is an apparent change rate of a travel distance required for the ultrasound signal to pass through the target region, the travel distance changing depending on the temperature in the target region; estimating, based on the estimated strain, a strain rate which is a temporal change rate of the strain; and estimating the temperature in the target region corresponding to the strain and the strain rate, based on a predetermined relationship between a strain, a strain rate, and a temperature.

According to this aspect, it is possible to estimate the temperature with a high accuracy in a wide temperature range.

The program according to an aspect of the present invention is a program for estimating a temperature in a target region using an ultrasound signal, and the program causes a computer to execute: receiving a scan signal generated by scanning the target region using the ultrasound signal, and estimating, based on the scan signal, an echo shift which is an amount of change in time required for the ultrasound signal to pass through the target region, the time changing depending on the temperature in the target region; estimating, based on the estimated echo shift, a strain which is an apparent change rate of a travel distance required for the ultrasound signal to pass through the target region, the travel distance changing depending on the temperature in the target region; estimating, based on the estimated strain, a strain rate which is a temporal change rate of the strain; and estimating the temperature in the target region corresponding to the strain and the strain rate, based on a predetermined relationship between a strain, a strain rate, and a temperature.

According to this aspect, it is possible to estimate the temperature with a high accuracy in a wide temperature range.

It is to be noted that these general and specific aspects may be implemented using a system, a method, an integrated circuit, a computer program, or a computer-readable recording medium, or any combination of systems, methods, integrated circuits, computer programs, or recording media.

### DESCRIPTION OF EMBODIMENTS

Hereinafter, embodiments of the present invention are described in detail with reference to the drawings. It is to be noted that each of the embodiments described below shows a general or specific example of the present invention. The numerical values, shapes, materials, structural elements, the arrangement of the structural elements, steps, the processing order of the steps etc. shown in the following embodiments are mere examples, and therefore do not limit the scope of the present invention. Furthermore, among the structural elements in the following embodiments, structural elements not recited in any one of the independent claims defining the most generic concept are described as arbitrary structural elements.

### Embodiment 1

### Overall Structure of Temperature Estimation Apparatus

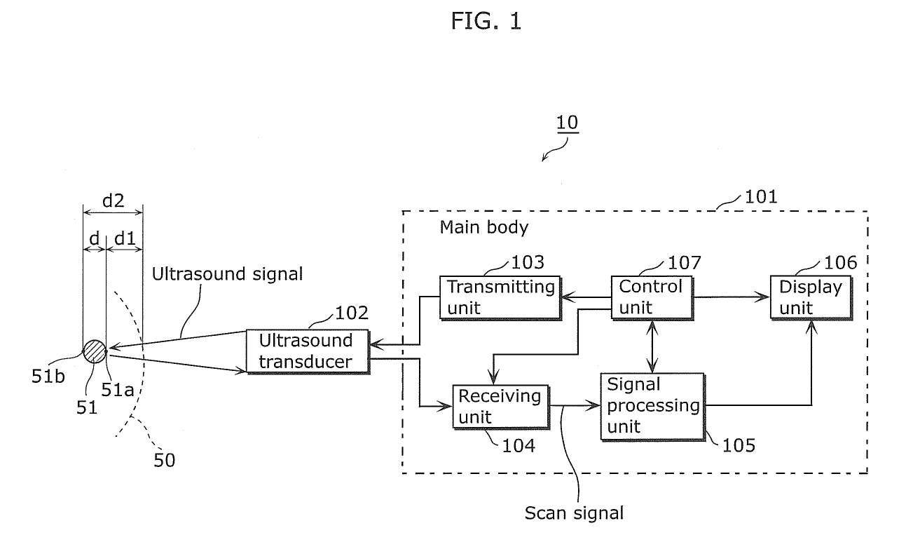

FIG. 1 is a block diagram of a structure of a temperature estimation apparatus according to Embodiment 1 of the present invention. As shown in FIG. 1, a temperature estimation apparatus 10 according to this embodiment includes a main body 101 and an ultrasound transducer 102.

The ultrasound transducer 102 transmits an ultrasound signal to a target region 51 in a living subject 50 (the target region is, for example, a treatment target area in an HIFU treatment) to scan the target region 51, and receives an ultrasound signal reflected from the target region 51.

The main body 101 includes a transmitting unit 103, a receiving unit 104, a signal processing unit 105, a display unit 106, and a control unit 107. The transmitting unit 103 supplies an electric signal (a transmission signal) to the ultrasound transducer 102 under control by the control unit 107, and to thereby cause the ultrasound transducer 102 to generate an ultrasound signal. The receiving unit 104 receives the electric signal (a reception signal) from the ultrasound transducer 102 under control by the control unit 107.

The signal processing unit 105 processes the electric signal (a scan signal) supplied from the receiving unit 104 to estimate a temperature in the target region 51. A temperature estimation method performed by the signal processing unit 105 is described later. The display unit 106 displays the temperature estimated by the signal processing unit 105 under control by the control unit 107. The display unit 106 is a liquid crystal display or the like.

The control unit 107 controls the whole temperature estimation apparatus 10 by controlling the transmitting unit 103, the receiving unit 104, the signal processing unit 105, and the display unit 106. The control unit 107 is a micro processor or the like.

### (Temperature Estimation Model)

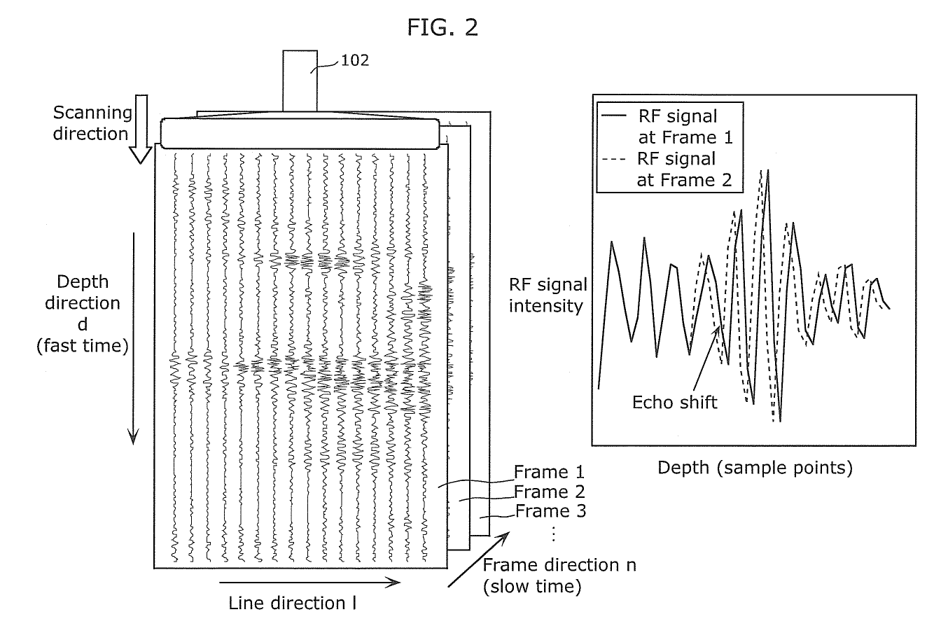

FIG. 2 is a diagram for illustrating a scan signal. As shown in FIG. 2, a scan signal has three dimensions that are a depth direction (d), a line direction (I), and a frame direction (n). The depth direction is a direction starting from a body surface toward the inside of the living subject 50, and the line direction is a direction approximately perpendicular to the depth direction. The frame direction is a time direction in which frames are switched. In general, the time in the depth direction is referred to as fast time, and the time in the frame direction is referred to as slow time.

The speed of the ultrasound signal, that is, the sound speed changes with change in the temperature in the target region 51. Such change in the speed of the ultrasound signal changes the time required for the ultrasound signal to pass through the target region 51. The amount of change in time required for the ultrasound signal to pass through the target region 51 depends on the temperature in the target region 51 as mentioned above, and this amount of change in time is referred to as an echo shift. For example, as shown in FIG. 2, a temporal difference between an RF signal (a scan signal) in Frame 1 and an RF signal in Frame 2 that is next to the Frame 1 are referred to as an echo shift.

As shown in FIG. 1, the ultrasound signal travels along the depth direction starting from the body surface toward the inside of the living subject 50. The sound speed is cₒ when the distance (depth) from the body surface to a first area 51a of the target region 51 of the living subject 50 is denoted by d₁, the distance (depth) from the body surface to a second area 51b of the target region 51 of the living subject 50 is denoted by d₂, the size in the depth direction of the target region 51 is denoted by d (=d₂−d₁), and the temperature in the target region 51 is Tₒ degrees Celsius. At this time, the time t_{f0} (fast time) required for the ultrasound signal to pass through the target region 51 is obtained according to the equation below.

$$\begin{matrix}[ Math . 1 ] & \\ {t}_{f 0} = \frac{d}{{c}_{0}} & ( Equation 1 )\end{matrix}$$

In Equation 1 and the succeeding equations, t_{f} denotes fast time, and n denotes slow time. When the temperature in the target region 51 changes from T₀ degrees Celsius to T₁ degrees Celsius, the time t_{f1} (fast time) required for the ultrasound signal to pass through the target region 51 is obtained according to the equation shown below.

$$\begin{matrix}[ Math . 2 ] & \\ {t}_{f 1} = \frac{d}{{c}_{1}} & ( Equation 2 )\end{matrix}$$

In Equation 2, c₁ denotes a sound speed in the case where the temperature in the target region 51 is T₁ degrees Celsius.

Accordingly, an echo shift ψ in the case where the temperature of the target region 51 is T₁ degrees Celsius shifted from T₀ degrees Celsius is represented as shown below.

$$\begin{matrix}[ Math . 3 ] & \\ ϕ = {t}_{f 0} - {t}_{f 1} = d ( \frac{1}{{c}_{0}} - \frac{1}{{c}_{1}} ) & ( Equation 3 )\end{matrix}$$

An apparent displacement amount Δdis of the travel distance required for the ultrasound signal to pass through the target region 51 when the temperature in the target region 51 changes from T₀ to T₁ degrees Celsius is represented according to the equation shown below.

$$\begin{matrix}[ Math . 4 ] & \\ Δ dis = {c}_{system} ϕ = {c}_{system} d ( \frac{1}{{c}_{0}} - \frac{1}{{c}_{1}} ) & ( Equation 4 )\end{matrix}$$

In Equation 4, c_{system} is a constant used as a sound speed in an ultrasound imaging system, and c_{system} is generally 1540 m per second.

A strain ε is represented below which is an apparent displacement rate of the travel distance required for the ultrasound signal to pass through the target region 51, and this apparent displacement rate depends on a temperature.

$$\begin{matrix}[ Math . 5 ] & \\ ɛ = \frac{Δ dis}{d} = {c}_{system} ( \frac{1}{{c}_{0}} - \frac{1}{{c}_{1}} ) & ( Equation 5 )\end{matrix}$$

In Equation 5, C_{system} is a constant, and thus the strain ε can be represented according to the equation below.

$$\begin{matrix}[ Math . 6 ] & \\ ɛ = \frac{\partial ϕ}{\partial d} & ( Equation 6 )\end{matrix}$$

Here, it is known that the sound speed c₁ and the temperature T satisfy a quadratic polynomial shown below.

### [Math. 7]

c₁=a₁T²+a₂T+a₃ (Equation 7)

Each of a₁, a₂, and a₃ is a constant temperature coefficient. In general, the amount of sound speed change depending on the temperature in the target region 51 is sufficiently smaller than the sound speed c₀ as represented according to the equation below.

### [Math. 8]

|c₁−c₀<<c₀ (Equation 8)

Thus, the following equation is obtained by combining Equations 5 and 7.

$$\begin{matrix}[ Math . 9 ] & \\ \begin{matrix}ɛ = {c}_{system} ( \frac{{c}_{1} - {c}_{0}}{{c}_{1} {c}_{0}} ) \\ \approx {c}_{system} ( \frac{{a}_{1} {T}^{2} + {a}_{2} T + {a}_{3} - {c}_{0}}{{c}_{0}^{2}} ) \\ = {a}_{4} {T}^{2} + {a}_{5} T + {a}_{6}\end{matrix} & ( Equation 9 )\end{matrix}$$

In Equation 9, each of a₄, aₛ, and a₆ is a constant as shown below.

$$\begin{matrix}[ Math . 10 ] & \\ {a}_{4} = \frac{{c}_{system}}{{c}_{0}^{2}} {a}_{1} , \\ {a}_{5} = \frac{{c}_{system}}{{c}_{0}^{2}} {a}_{2} , \\ {a}_{6} = \frac{{c}_{system}}{{c}_{0}^{2}} ( {a}_{3} - {c}_{0} ) & ( Equation 10 )\end{matrix}$$

Expression 9 that is a model equation is similar to the model equation used in the aforementioned conventional temperature estimation method 1.

In the temperature estimation method according to this embodiment, the temperature in the target region 51 is estimated using Equation 16 that is a model equation (described later) derived by combining the aforementioned model equation Expression 9 and the Penne's bio-heat transfer equation. The Penne's bio-heat transfer equation is a differential equation representing the thermal transfer inside a living subject, as shown below.

$$\begin{matrix}[ Math . 11 ] & \\ ρυ \frac{\partial T}{\partial {t}_{s}} = ∇ \cdot ( κ ∇ T ) + {ρ}_{b} {υ}_{b} ωΔ T + {Q}_{met} & ( Equation 11 )\end{matrix}$$

In Equation 11: Qₘₑₜ denotes metabolic heat generation; ΔT denotes a temperature increasing above ambient; ρ denotes a tissue density; u denotes the specific heat of a tissue; ρ_{b} denotes a blood density; u_{b} denotes a specific heat of blood; ω denotes a blood perfusion rate; and κ denotes the thermal conductivity of a tissue.

Here, it is assumed that: (1) only the temperature change in the target region 51 in the frame direction is considered; (2) the properties of the respective tissue and blood do not change with time; (3) the tissue temperature distribution is homogenous before measurement; and (4) the metabolic heat generation of the tissue does not change with time. Thus, each of ΔT=T−T₀ (T₀ denoting the temperature baseline) and T₀ is a constant. Each of Qₘₑₜ, ρ, u, ρ_{b}, u_{b}, ω, and κ is also a constant. ∇(napla)²T is a constant, since it does not change with time. Equation 11 can be rewritten as shown below.

$$\begin{matrix}[ Math . 12 ] & \\ \frac{\partial T}{\partial n} = {a}_{7} T + {a}_{8} & ( Equation 12 )\end{matrix}$$

In Equation 12, each of a₇ and a₈ is a constant that satisfies the equation shown below.

$$\begin{matrix}[ Math . 13 ] & \\ {a}_{7} = \frac{{ρ}_{b} {υ}_{b} ω}{ρυ} , \\ {a}_{8} = ( ∇ \cdot ( κ ∇ T ) - {ρ}_{b} {υ}_{b} ω {T}_{0} + {Q}_{met} ) \frac{1}{ρυ} & \end{matrix}$$

Next, the strains and temperatures both represented by a function are continuous along the slow time, the strain rate can be obtained by calculating the partial derivative function for both the sides of Equation 9.

$$\begin{matrix}[ Math . 14 ] & \\ ξ = \frac{\partial ɛ}{\partial n} = ( 2 {a}_{4} T + {a}_{5} ) \frac{\partial T}{\partial n} & ( Equation 13 )\end{matrix}$$

In Equation 13, ξ denotes a strain rate. The strain rate ξ is a temporal change rate of the strain ε. In other words, the strain rate ξ is the mixed partial derivative function of the echo shift ψ along the depth d in the depth direction and the time (slow time) n.

$$\begin{matrix}[ Math . 15 ] & \\ ξ = \frac{\partial ϕ}{\partial d \partial n} & ( Equation 14 )\end{matrix}$$

Assuming that the temperature estimated according to the Penne's bio-heat transfer equation is equal to an actual temperature, the following Equation 15 can be obtained by combining Equation 12 and Equation 13.

[Math. 16]

ξ=(2a₄T+a₅)(a₇T+a₈)=2a₄a₇T²+(2a₄a₈+a₅a₇)T+a₅a₈=a₉T²+a₁₀T+a₁₁ (Equation 15)

Combining Equation 9 and Equation 15 to eliminate the quadratic term (T²) results in the following Equation.

### [Math. 17]

T=a₁₂ε+a₁₃ξa₁₄ (Equation 16)

In Equation 16, each of a₁₂, a₁₃, and a₁₄ is a constant that satisfies the equation shown below.

$$\begin{matrix}[ Math . 18 ] & \\ {a}_{12} = \frac{{a}_{9}}{{a}_{5} {a}_{9} - {a}_{4} {a}_{10}} , \\ {a}_{13} = \frac{{a}_{4}}{{a}_{4} {a}_{10} - {a}_{5} {a}_{9}} , \\ {a}_{14} = \frac{{a}_{4} {a}_{11} - {a}_{6} {a}_{9}}{{a}_{5} {a}_{9} - {a}_{4} {a}_{10}} & \end{matrix}$$

The model equation Equation 16 is a linear model equation showing the predetermined relationship between the strain ε, the strain rate ξ, and the time T. The temperature estimation method according to this embodiment is intended to estimate a temperature in the target region 51 using this model equation as described later.

### (Structure of Signal Processing Unit)

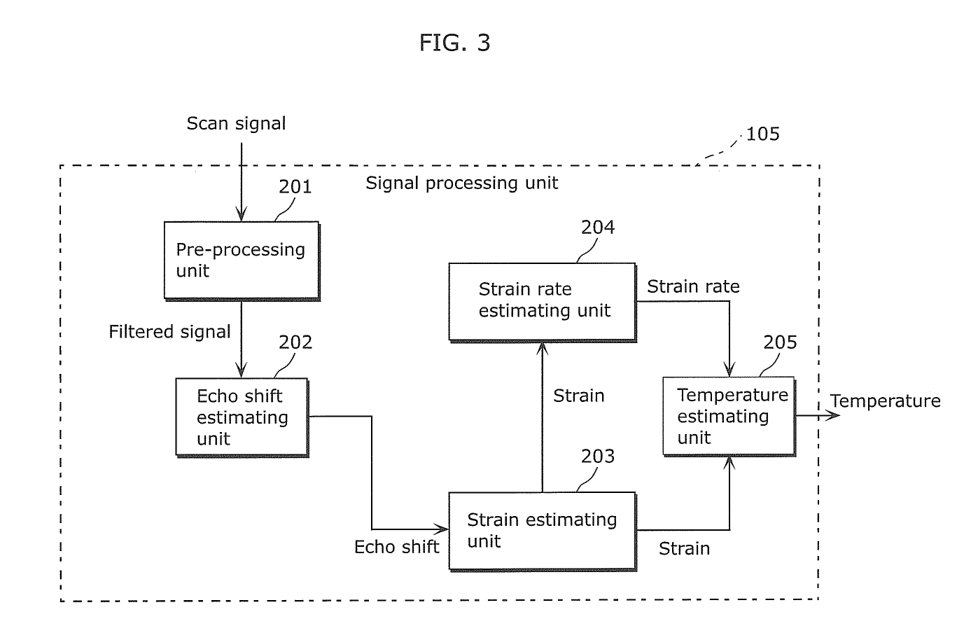

FIG. 3 is a block diagram of a specific structure of a signal processing unit in FIG. 1. As shown in FIG. 3, the signal processing unit 105 includes a pre-processing unit 201, an echo shift estimating unit 202, a strain estimating unit 203, a strain rate estimating unit 204, and a temperature estimating unit 205.

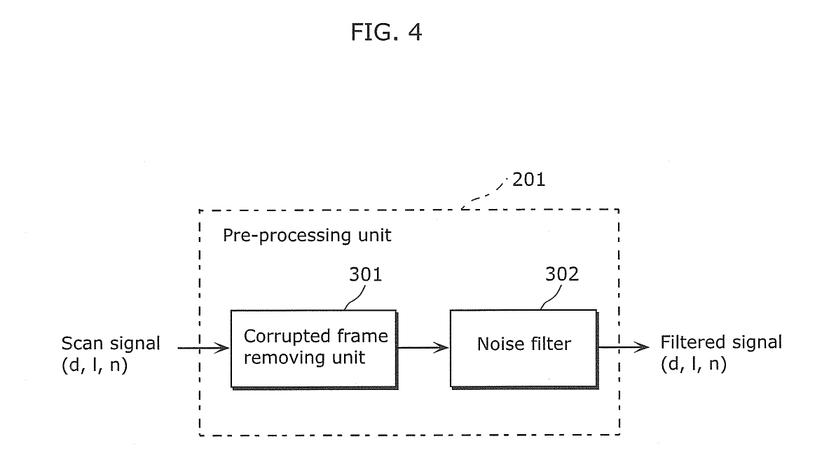

FIG. 4 is a block diagram of a specific structure of the pre-processing unit. As shown in FIG. 4, the pre-processing unit 201 includes a corrupted frame removing unit 301, and a noise filter 302. The corrupted frame removing unit 301 removes corrupted frames from a scan signal (pre-processing step). The corrupted frames are caused due to disturbance (such as environmental noise, externally processed signals, and high intensity focused ultrasound used in an HIFU treatment). Here, in a “scan signal (d, l, n)” etc. in FIG. 3 and the succeeding drawings, d denotes the dimension in the depth direction, l denotes the dimension in the line direction, and n denotes the dimension in the frame direction.

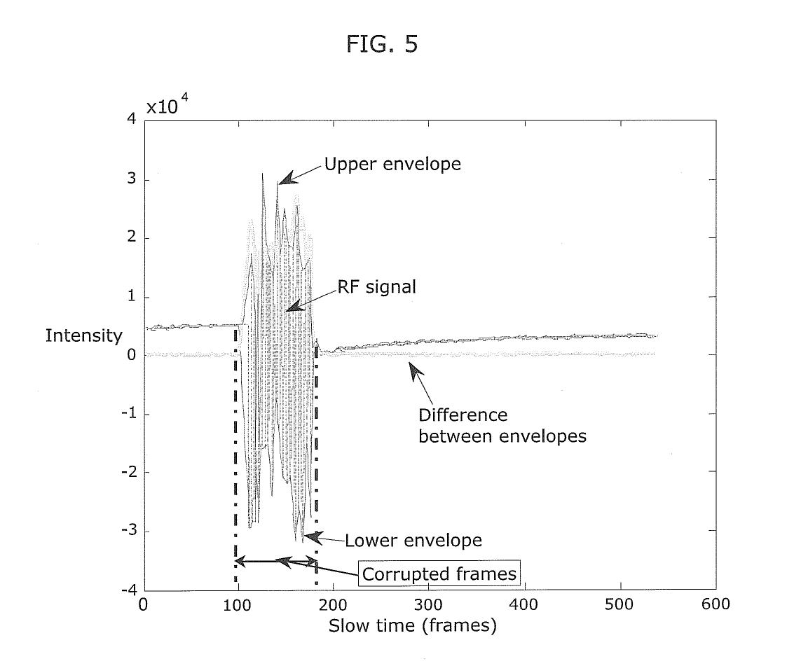

FIG. 5 is a diagram showing corrupted frames in a scan signal. As shown in FIG. 5, in the corrupted frames, the intensity amplitude of the scan signal (RF signal) is abnormally large.

The corrupted frame removing unit 301 detects an upper envelope and a lower envelope in the graph of the intensity of the scan signal, and then calculates, for each frame, the difference between the upper envelope and the lower envelope. Next, the corrupted frame removing unit 301 determines, to be the corrupted frames, the frames each having an inter envelope difference exceeding a predetermined threshold value, and removes the corrupted frames from the scan signal. The frames each having the inter envelope difference exceeding the predetermined threshold value are, for example, frames in a heating stage in which a high intensity focused ultrasound is emitted in an HIFU treatment. The frames each having the inter envelope difference smaller than the predetermined threshold value are, for example, frames in a cooling stage after the emission of the high intensity focused ultrasound in the HIFU treatment. In this way, the frames of the scan signal in the cooling stage in the HIFU treatment are used for temperature estimation performed by the temperature estimating unit 205 described in detail later, while the frames (that are corrupted frames) of the scan signal in the heating state in the HIFU treatment are not used for the temperature estimation performed by the temperature estimating unit 205.

The scan signal output from the corrupted frame removing unit 301 is subjected to noise attenuation in the noise filter 302, and then is output from the noise filter 302 as a filtered signal (that is, the scan signal already subjected to the filtering).

It is to be noted that, in the pre-processing unit 201, it is also possible to perform processing including body movement compensation and blood flow compensation. The body movement can be detected by using an ultrasound signal (or an image) in a motion estimation technique or by using accelerated sensors or the like. The blood flow can be detected by using ultrasound Doppler signal processing.

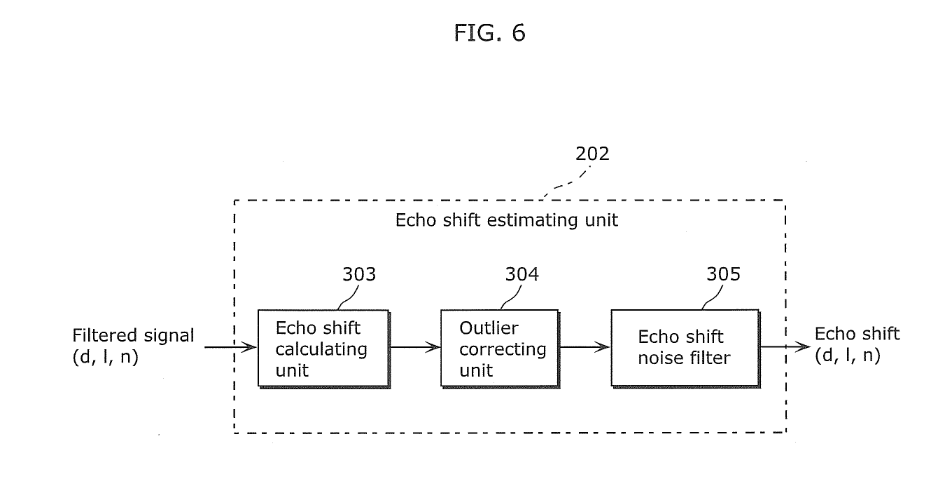

FIG. 6 is a block diagram of a specific structure of the echo shift estimating unit. As shown in FIG. 6, the echo shift estimating unit 202 includes an echo shift calculating unit 303, an outlier correcting unit 304, and an echo shift noise filter 305. The echo shift estimating unit 202 estimates an echo shift based on a filtered signal (scan signal) as described later (an echo shift estimating step).

The echo shift calculating unit 303 calculates a raw echo shift based on the filtered signal output from the pre-processing unit 201 (an echo shift calculating step). Exemplary methods for calculating a raw echo shift include an autocorrelation method and a cross-correlation method.

In the autocorrelation method, for example, SDopp estimation method is used. In this SDopp estimation method, an echo shift is calculated using a large number of IQ data items that are spatially in contact with each other. The echo shift calculated using the SDopp estimation method is represented according to the equation shown below.

$$\begin{matrix} [ Math . 19 ] & \\ ϕ ( d , n ) = \frac{1}{4 π} arg \{ {\sum }_{{x}_{1} = 2 - k}^{0} {\sum }_{{x}_{2} = 2 - y}^{0} I ( d - {x}_{1} , n - {x}_{2} ) {I}^{*} ( d - {x}_{1} , n - {x}_{2} - 1 ) \} & ( Equation 17 )\end{matrix}$$

In Equation 17, ψ(d, n) is an echo shift in the case of the depth d^{th} and the time (slow time) n^{th}. In Equation 17, k denotes the number of samples in the depth direction in which the echo shift is calculated, and y denotes the number of frames with which the echo shift is calculated. In Equation 17, I (d, n) denotes an IQ segment selected from the d^{th} depth and n^{th} time (slow time). In the SDopp estimation method, the size of a window (k*y) may be a fixed value, or be variable according to change in the properties of the scan signal (the change is, for example, change in the amplitude or energy).

The cross-correlation method is, for example, mathematically represented according to the following Equation 18.

$$\begin{matrix} [ Math . 20 ] & \\ γ ( β ) = {max}_{β} {\sum }_{d = 0}^{d = k - 1} \frac{( {s}_{n} ( d ) - {s}_{n}^{mean} ) ( {s}_{n + 1} ( d + β ) - {s}_{n + 1}^{mean} )}{{s}_{n}^{RMS} {s}_{n + 1}^{RMS}} , \\ - \frac{q}{2} < β < \frac{q}{2} & ( Equation 18 )\end{matrix}$$

In Equation 18, Sₙ denotes an RF segment in Frame n, Sₙ₊₁ denotes an RF segment in Frame n+1 adjacent to Frame n. In Equation 18, Sₙ^{mean} and Sₙ^{RMS} denote the mean and the root mean square of the segment, respectively. In Equation 18, k denotes the window length of the segment, q denotes a search range in an RF line of the frame, and γ denotes a cross-correlation coefficient. β equals to the echo shift between two segments when γ(β) is a maximum value.

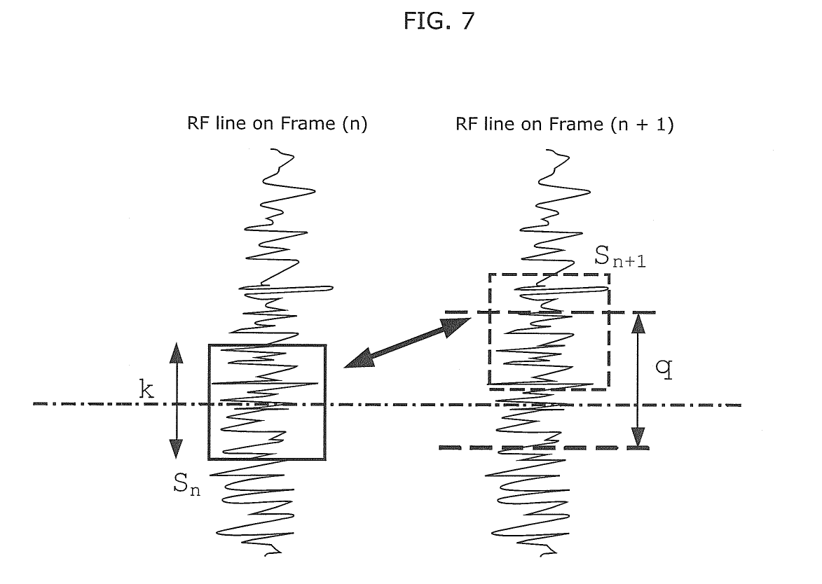

FIG. 7 is a diagram for illustrating an echo shift calculating step. As shown in FIG. 7, the echo shift calculating unit 303 firstly multiplexes the segment Sₙ by the window (Sₙ₊₁) in the state where the window (Sₙ₊₁) is positioned at the top of the search range q in Frame n+1. This calculation step is performed for each data point, and the sum of the values is stored as a variable. Next, the echo shift calculating unit 303 iterates the aforementioned calculations while shifting, for each sample, the window (Sₙ₊₁) until the window (Sₙ₊₁) reaches the bottom end of the search range q. The echo shift calculating unit 303 determines, to be a raw echo shift, β at the time when γ(β) reaches the maximum value.

The outlier correcting unit 304 corrects the outliers that are not caused due to a temperature change, in the raw echo shift calculated by the echo shift calculating unit 303 (an outlier correcting step). The raw echo shift includes both an echo shift that is caused by a temperature change and outliers that are not caused by any temperature change (such outliers are caused, for example, by vibration). These outliers significantly decrease the accuracy in the temperature estimation. By correcting these outliers, it is possible to generate an echo shift that is caused by a temperature change. For example, the outlier correcting unit 304 removes such outliers based on an echo shift prediction model. This echo shift prediction model is an error function or a complementary error function.

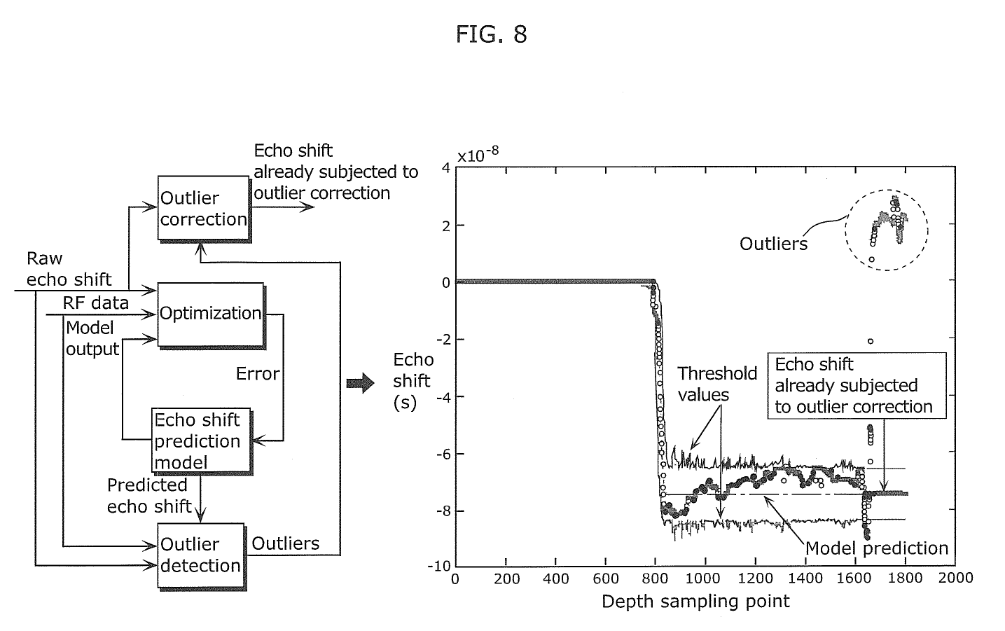

When the error function is used as the echo shift prediction model, the aforementioned outlier correcting step is performed as indicated below. FIG. 8 is a diagram for illustrating the outlier correcting step. First, based on the raw echo shift calculated in the echo shift calculating step, the parameters of the echo shift prediction model for calculating the predicted echo shift are adjusted (a parameter adjusting step). Next, based on the optimized echo shift prediction model, the predicted echo shift is calculated (a predicted echo shift calculating step). Subsequently, based on the predicted echo shift and an RF signal generated by scanning the target region 51, the upper threshold value and the lower threshold value are set (a threshold value setting step). In this threshold value setting step, the gap between the upper threshold value and the lower threshold value is set based on experimental study etc. (a gap setting step), and the upper threshold value and the lower threshold value are adjusted using the intensity of the RF signal as weights (a threshold value adjusting step). Subsequently, the data points which are outliers each exceeding the upper threshold value or the lower threshold value among the data points of the raw echo shift are corrected to fit the data points corresponding to the predicted echo shift (a data point correcting step).

The echo shift noise filter 305 attenuates noise included in the echo shift by increasing the SN ratio of the echo shift caused by a temperature change (a noise attenuating step). The echo shift noise filter 305 is, for example, a low-pass filter or a band-pass filter. The echo shift subjected to noise reduction by the echo shift noise filter 305 is output from the echo shift noise filter 305.

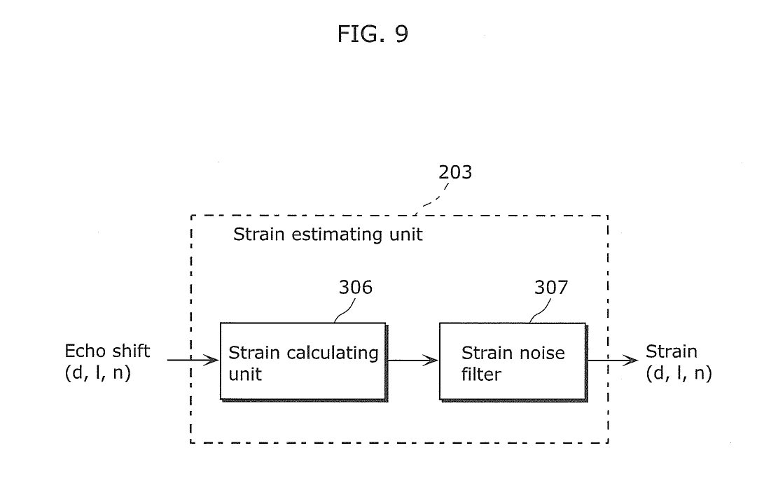

FIG. 9 is a block diagram of a specific structure of the strain estimating unit. The strain estimating unit 203 includes a strain calculating unit 306 and a strain noise filter 307. The strain calculating unit 306 calculates a partial derivative function (that is, a strain ε) of an echo shift ψ along the depth d as shown in Equation 6 (a strain calculating step).

The strain calculating unit 306 calculates the strain, for example, by using a weighted least square algorithm. The weighted least square algorithm is an algorithm according to a least squares method by introducing the weights associated with data points into a fitting criterion. The strain calculating unit 306 firstly calculates the strain using the echo shift obtained from three or more samples according to the weighted least square algorithm. In this way, the parameters of a linear function are adjusted to fit a preset data, in other words, the mean square error between a model and the data is minimized. The strain ε is determined using the weighted least square algorithm such as the equation shown below.

$$\begin{matrix}[ Math . 21 ] & \\ ɛ = \frac{N \cdot {\sum }_{i = 1}^{N} {ϕ}_{i} {d}_{i} - {\sum }_{i = 1}^{N} {φ}_{i} {\sum }_{i = 1}^{N} {d}_{i}}{N \cdot {\sum }_{i = 1}^{N} {( {d}_{i} )}^{2} - {( {\sum }_{i = 1}^{N} {d}_{i} )}^{2}} & ( Equation 19 )\end{matrix}$$

In Equation 19, N denotes the number of samples, ψ denotes an echo shift at each sample point, and d denotes the depth index of the sample point.

In order to increase the SN ratio, a weighed linear regression is introduced. More specifically, in order to calculate a strain value, each echo shift is weighted in proportion to the intensity of a corresponding one of RF points. In this way, it is possible to emphasize the sample point using a higher SN ratio. The strain ε in Equation 19 is corrected as shown below.

$$\begin{matrix}[ Math . 22 ] & \\ ɛ = \frac{{\sum }_{i = 1}^{N} {I}_{i} \cdot {\sum }_{i = 1}^{N} {I}_{i} {ϕ}_{i} {d}_{i} - {\sum }_{i = 1}^{N} {I}_{i} {ϕ}_{i} {\sum }_{i = 1}^{N} {I}_{i} {d}_{i}}{{\sum }_{i = 1}^{N} {I}_{i} \cdot {\sum }_{i = 1}^{N} {{I}_{i} ( {d}_{i} )}^{2} - {( {\sum }_{i = 1}^{N} {I}_{i} {d}_{i} )}^{2}} & ( Equation 20 )\end{matrix}$$

In Equation 20, I denotes the intensity of the RF point for calculating the displacement in the sample.

The strain noise filter 307 attenuates noise generated in the strain due to small environmental disturbance. The strain noise filter 307 is, for example, a two-dimensional median filter along depth and time. The strain already subjected to the noise reduction by the strain noise filter 307 is output from the strain noise filter 307.

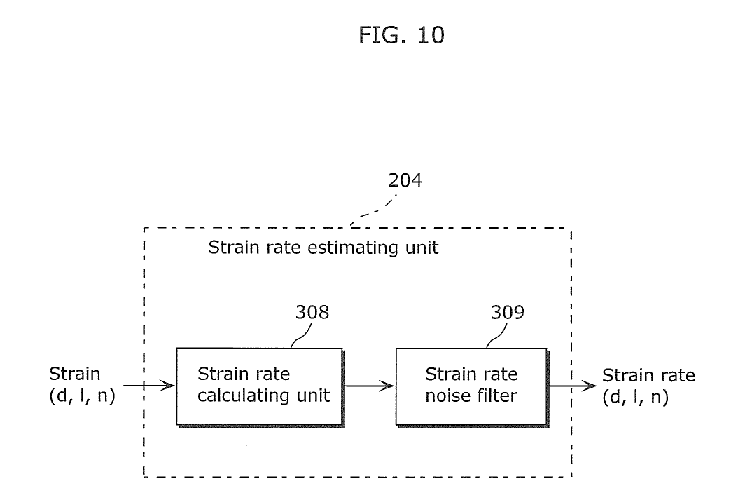

FIG. 10 is a block diagram of a specific structure of the strain rate estimating unit. As shown in FIG. 10, the strain rate estimating unit 204 includes a strain rate calculating unit 308 and a stain rate noise filter 309. The strain rate estimating unit 204 estimates a strain rate based on the calculated strain (a strain rate calculating step). As described above, the strain rate ξ is a mixed partial derivative function of the echo shift ψ along the depth d and time (slow time) n (see Equation 14).

The strain rate calculating unit 308 calculates the strain rate directly or indirectly from the echo shift. Non-limiting and exemplary methods for indirectly calculating a strain rate includes a method for calculating a strain rate based on a strain (a partial derivative function of an echo shift along depth) or a speed (a partial derivative function of an echo shift along time (slow time)).

Exemplary methods for indirectly calculating a strain rate includes a numeric differentiation method. The echo shift ψ can be represented as an independent variable of depth d and time (slow time) n according to the equation shown below.

### [Math. 23]

φ=ƒ(d,n) (Equation 21)

The mixed partial derivative function of the echo shift is continuous at the d-n plane, and can be represented as shown below.

$$\begin{matrix}[ Math . 24 ] & \\ ξ = \frac{{\partial }^{2} f}{\partial d \partial n} = \frac{{\partial }^{2} f}{\partial n \partial d} & ( Equation 22 )\end{matrix}$$

The numerical solution of the mixed partial derivative function of Equation 22 can be the following equation.

$$\begin{matrix} [ Math . 25 ] & \\ ξ ( {d}_{i} , {n}_{j} ) \approx \frac{1}{4 {α}_{h} {α}_{k}} ( {ϕ}_{i + 1 , j + 1} - {ϕ}_{i + 1 , j - 1} - {ϕ}_{i - 1 , j + 1} + {ϕ}_{i - 1 , j - 1} ) , \\ with {ϕ}_{i , j} = f ( {d}_{i} , {n}_{j} ) & ( Equation 23 )\end{matrix}$$

In Equation 23, aₕ=dᵢ₊₁−dᵢ, aₖ=nⱼ₊₁−nⱼ=nⱼ−nⱼ₋₁, and i and j are the indexes of data points.

Another exemplary method for directly calculating a strain rate is a least squares method. It is assumed that the echo shift is fitted with the curve shown below.

$$\begin{matrix}[ Math . 26 ] & \\ {{ϕ}^{⋒}}_{i , j} = ɛ {d}_{i} + b \\ ɛ = \frac{\partial ϕ}{\partial d} & ( Equation 24 )\end{matrix}$$

In Equation 24, the value of the echo shift fitted at the point (dᵢ, nⱼ) is denoted by the following symbol.

### [Math. 27]

\hat{φ}_{i,j}

The strain rate ξ is defined below.

$$\begin{matrix}[ Math . 28 ] & \\ ɛ ( {d}_{i} , {n}_{j} ) = ξ {n}_{j} + κ \\ ξ = \frac{\partial ɛ}{\partial n} & ( Equation 25 )\end{matrix}$$

By combining Equation 24 and Equation 25, we obtain a linear model equation to predict an echo shift based on a depth and the product of the depth and time (slow time) of the scan signal. This linear model equation is shown below.

### [Math. 29]

\hat{φ}_{i,j}=ξdᵢnⱼ+κdᵢ+b (Equation 26)

As shown in the following Equation 27, the value of ξ to be calculated for the given data set of (d₁, n₁, ψ_{1, 1}), (d₂, n₂, ψ_{1, 2}), . . . (dₙ, nₘ, ψ_{n, m}) is a value that minimizes the error between the echo shift ψ_{i, j} calculated based on the scan signal and the echo shift predicted according to the linear model equation shown as Equation 26.

$$\begin{matrix}[ Math . 30 ] & \\ Π = {\sum }_{i = 1}^{k} {\sum }_{j = 1}^{y} {[ {ϕ}_{i , j} - ( ξ {d}_{i} {n}_{j} + κ {d}_{i} + b ) ]}^{2} & ( Equation 27 )\end{matrix}$$

In Equation 27, k and y are the number of samples and the number of frames, respectively, in the depth direction in which the strain rate is estimated and predicted. All the dᵢ, nᵢ, and ψ_{i, j} are known, but ξ, b, and κ are unknown coefficients. In order to obtain the least square error, a first derivative function is generated for the unknown coefficients ξ, b, and κ.

$$\begin{matrix}[ Math . 31 ] & \\ \{ \begin{matrix}\frac{\partial Π}{\partial ξ} = - 2 {\sum }_{i = 1}^{k} {\sum }_{j = 1}^{y} {d}_{i} {n}_{j} [ {ϕ}_{i , j} - ( ξ {d}_{i} {n}_{j} + κ {d}_{i} + b ) ] = 0 \\ \frac{\partial Π}{\partial κ} = - 2 {\sum }_{i = 1}^{k} {\sum }_{j = 1}^{y} {d}_{i} [ {ϕ}_{i , j} - ( ξ {d}_{i} {n}_{j} + κ {d}_{i} + b ) ] = 0 \\ \frac{\partial Π}{\partial b} = - {\sum }_{i = 1}^{k} {\sum }_{j = 1}^{y} [ {ϕ}_{i , j} - ( ξ {d}_{i} {n}_{j} + κ {d}_{i} + b ) ] = 0\end{matrix} & ( Equation 28 )\end{matrix}$$

According to Equation 28, the value of the strain rate can be obtained.

The strain rate noise filter 309 attenuates the noise generated in the strain rate. The strain rate already subjected to the noise reduction by the strain rate noise filter 309 is output from the strain rate noise filter 309.

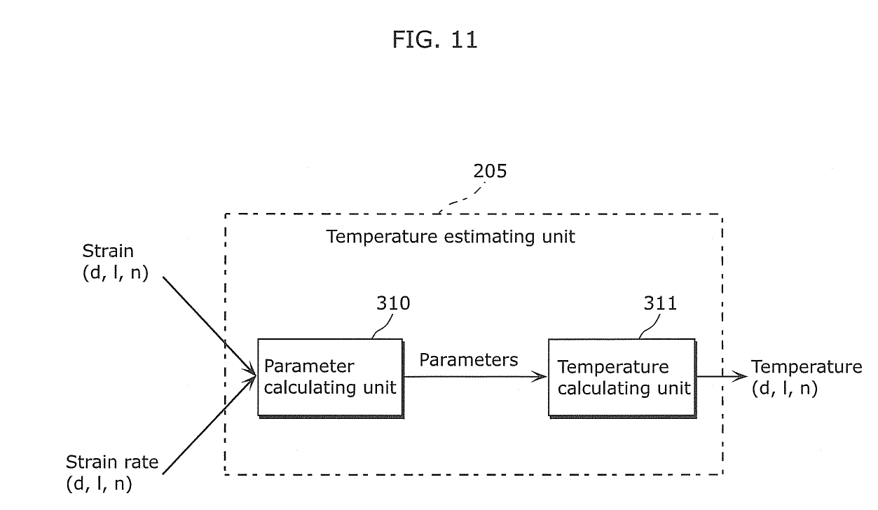

FIG. 11 is a block diagram of a specific structure of a temperature estimating unit. As shown in FIG. 11, the temperature estimating unit 205 includes a parameter calculating unit 310 and a temperature calculating unit 311. The temperature estimating unit 205 estimates a temperature based on the calculated strain and strain rate (a temperature estimating step).

The parameter calculating unit 310 calculates the linear model equation shown as Equation 16 to obtain the algorithm parameters a₁₂, a₁₃, and a₁₄, based on the calculated strain and strain rate. These algorithm parameters are identified by executing the steps as shown below.

First, thermocouples (not shown) are aligned with the target region 51 to be heated (an aligning step). Subsequently, the temperatures in the target region 51 are measured by the thermocouples (a temperature measuring step). The temperatures measured by the thermocouples are assumed to be denoted by the symbol below.

### [Math. 32]

\hat{T}

Then, an estimated temperature in the target region 51 is derived based on a scan signal generated by scanning the target region 51 (an estimated temperature deriving step). The estimated temperature based on the strain and strain rate can be calculated by substituting the strain and strain rate in the following data set into Equation 16.

### [Math. 33]

(\hat{T}₁,ε₁, ξ₁),(\hat{T}₂, ε₂,ξ₂), . . . (\hat{T}ₙ, εₙ, ξₙ)

The error between the temperature measured in the temperature measuring step and the estimated temperature derived in the estimated temperature deriving step is represented as a residual sum of squares.

$$\begin{matrix}[ Math . 34 ] & \\ err = {\sum }_{i = 1}^{N} {( {{T}^{⋒}}_{i} - {T}_{i} )}^{2} = {\sum }_{i = 1}^{N} {( {{T}^{⋒}}_{i} - {a}_{12} {ɛ}_{i} - {a}_{13} {ξ}_{i} - {a}_{14} )}^{2} & ( Equation 29 )\end{matrix}$$

In order to minimize the function err in Equation 29, a first derivative function is generated for the unknown coefficients a₁₂, a₁₃, and a₁₄.

$$\begin{matrix}[ Math . 35 ] & \\ \{ \begin{matrix}\frac{\partial err}{\partial {a}_{12}} = - 2 {\sum }_{i = 1}^{N} {ɛ}_{i} ( {{T}^{⋒}}_{i} - {a}_{12} {ɛ}_{i} - {a}_{13} {ξ}_{i} - {a}_{14} ) = 0 \\ \frac{\partial err}{\partial {a}_{13}} = - 2 {\sum }_{i = 1}^{N} {ξ}_{i} ( {\hat{T}}_{i} - {a}_{12} {ɛ}_{i} - {a}_{13} {ξ}_{i} - {a}_{14} ) = 0 \\ \frac{\partial err}{\partial {a}_{14}} = - 2 {\sum }_{i = 1}^{N} ( {{T}^{⋒}}_{i} - {a}_{12} {ɛ}_{i} - {a}_{13} {ξ}_{i} - {a}_{14} ) = 0\end{matrix} & ( Equation 30 )\end{matrix}$$

By solving Equation 30, the algorithm parameters a₁₂, a₁₃, and a₁₄ are identified (an algorithm parameter identifying step).

The temperature calculating unit 311 substitutes the calculated algorithm parameters in Equation 16, and calculates Equation 16 to estimate a temperature based on the calculated strain and strain rate.

It is to be noted that the aforementioned aligning step requires an accurate alignment of the thermocouples with the target region 51 to be heated, to cover the whole range of temperature change. In the aligning step, the thermocouples are firstly aligned, by using B-mode image, with the target region 51 to be heated. Then, in order to change the temperature in the target region 51, a heat source (not shown) that outputs an ultrasound signal is turned ON, and the temperatures in the target region 51 are measured by the thermocouples each time the heat source is shifted in a space. The shift of the heat source is stopped when the temperatures measured by the thermocouples reach to the minimum. In this way, the relative positional relationships between the thermocouples and the heat source are determined.

### (Temperature Estimation Method)

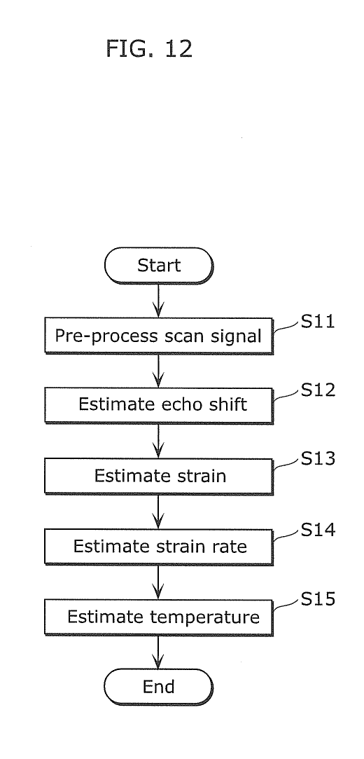

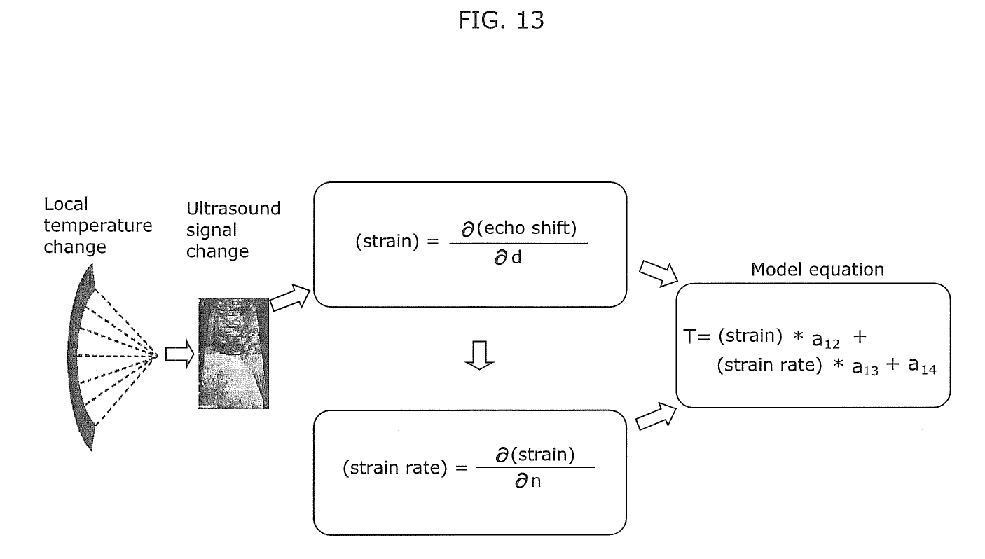

FIG. 12 is a flowchart of temperature estimation using a temperature estimation method according to Embodiment 1 of the present invention. FIG. 13 is a diagram for illustrating a temperature estimating step.

First, a scan signal generated by scanning a target region 51 using an ultrasound signal is received, and corrupted frames in the scan signal corrupted due to disturbance are removed (a pre-processing step) (S11). Then, an echo shift is calculated based on the scan signal from which the corrupted frames are already removed (an echo shift calculating step) (S12). Then, a strain is calculated based on the calculated echo shift (a strain calculating step) (S13). Next, a strain rate is calculated based on the calculated strain (a strain rate calculating step) (S14). Next, as shown in FIG. 13, a temperature in a target region 51 is estimated based on the calculated strain and strain rate according to the linear model equation shown as Equation 16 (a temperature estimating step) (S15).

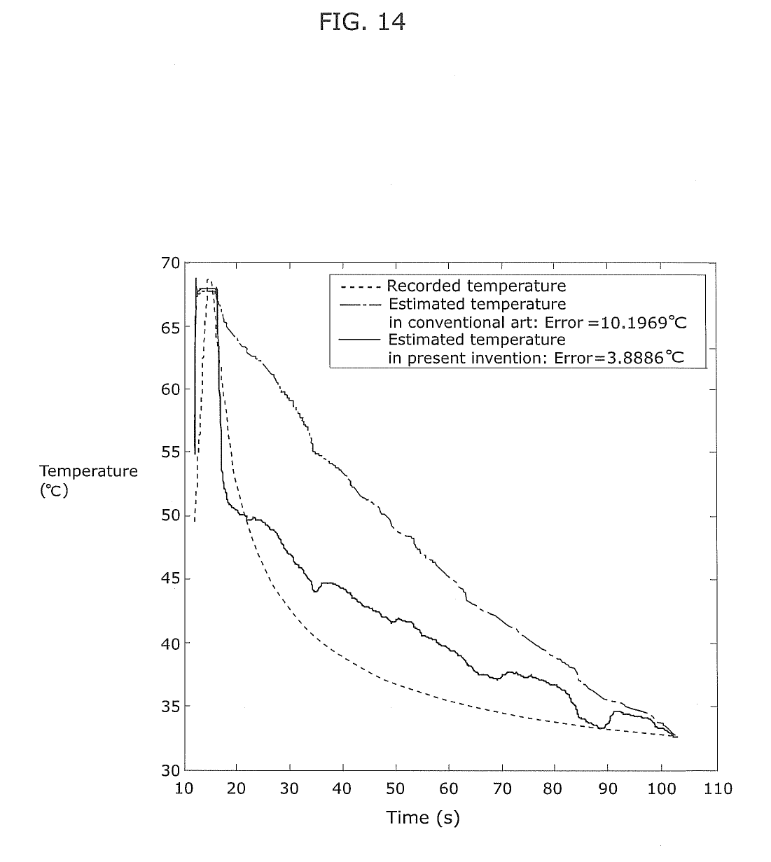

According to the temperature estimation method as described above, it is possible to estimate the temperature with an accuracy higher than conventional. FIG. 14 is a diagram showing results of a trial using a temperature estimation method according to the present invention and a comparison trial using a conventional temperature estimation method. In the graph of FIG. 14, the solid line shows temporal temperature variation estimated using the temperature estimation method according to Embodiment 1, and the dash-dot line shows temporal temperature variation estimated using the aforementioned conventional temperature estimation method 1. The broken line in the graph shows a temporal variation of recorded actual temperatures. As clear from FIG. 14, the temperature estimated using the temperature estimation method according to Embodiment 1 yields a smaller error from the actual temperature compared to the temperature estimated using the conventional temperature estimation method. Judging from the results of the trials, it can be understood that the temperature estimation method according to this embodiment enables highly accurate temperature estimation.

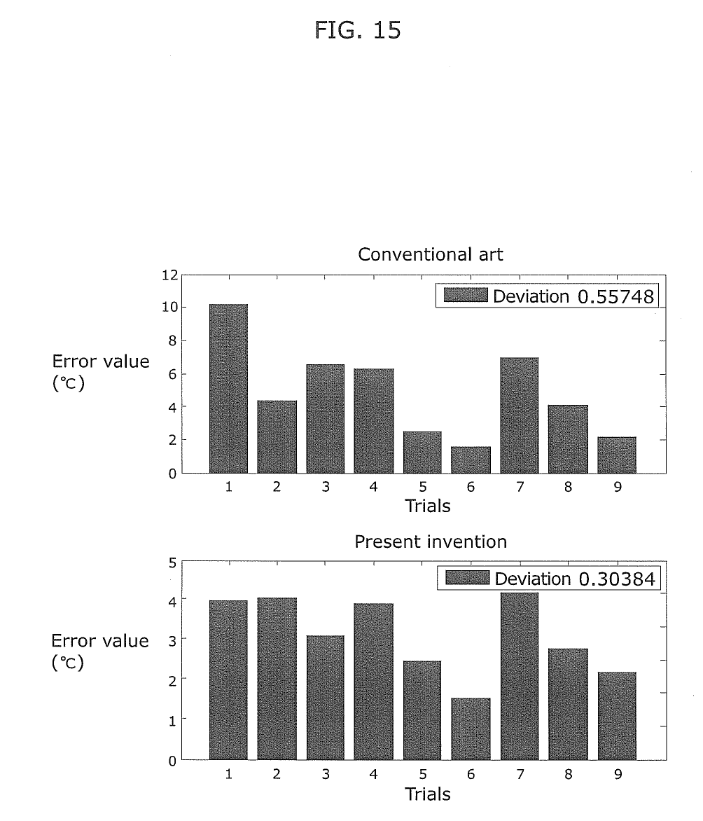

FIG. 15 is a diagram showing results of a trial using a temperature estimation method according to the present invention and a comparison trial using a conventional temperature estimation method. In FIG. 15, the upper graph shows the results of nine trials for calculating errors (specifically, root mean square errors) between the temperatures estimated using the conventional temperature estimation method 1 and recorded actual temperatures. The lower graph shows the results of nine trials for calculating errors between the temperatures estimated using the temperature estimation method according to Embodiment 1 and recorded actual temperatures. As clear from FIG. 15, the standard deviation of the temperatures estimated using the temperature estimation method according to Embodiment 1 are smaller than the standard deviation of the temperatures estimated using the conventional temperature estimation method 1. Judging also from the results of the trials, it can be understood that the temperature estimation method according to this embodiment enables highly accurate temperature estimation.

### Embodiment 2

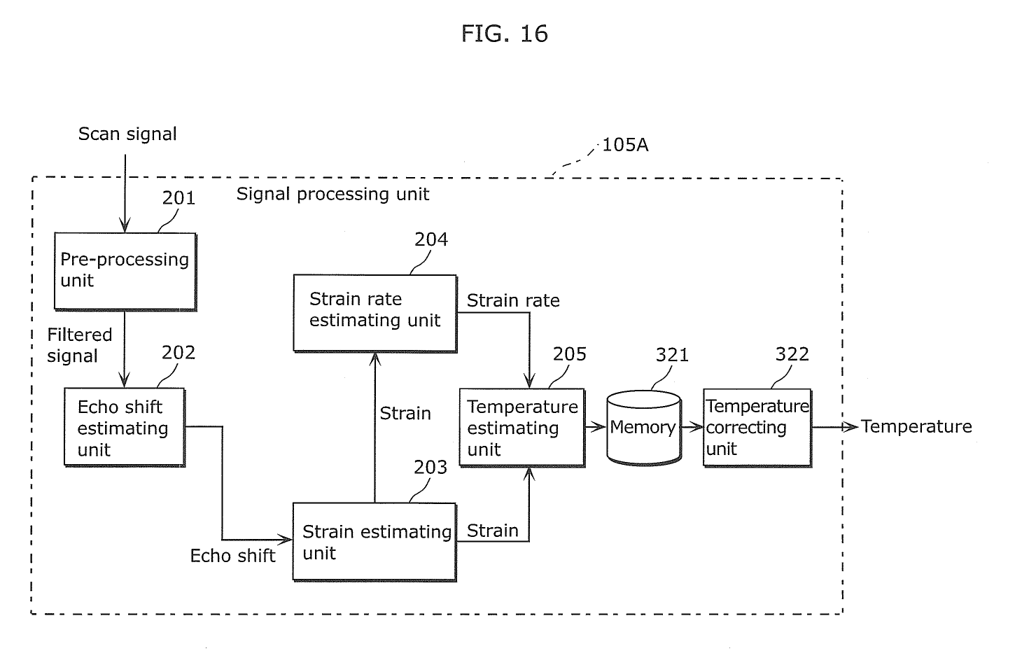

FIG. 16 is a block diagram of a structure of a temperature estimation apparatus according to Embodiment 2 of the present invention. A temperature estimation apparatus according to this embodiment includes a signal processing unit 105A that further includes a memory 321 and a temperature correcting unit 322. The memory 321 stores temperatures corresponding to one frame (or a plurality of frames) estimated by the temperature estimating unit 205. The temperature correcting unit 322 corrects the temperatures corresponding to the one frame (or the plurality of frames) stored in the memory 321, based on an objective function f₁ considering spatial continuity of temperatures (a temperature correcting step). This temperature correcting step is executed after the aforementioned temperature estimating step.

The aforementioned objective function f₁ can be represented as the equation below.

$$\begin{matrix}[ Math . 36 ] & \\ {f}_{1} = {\sum }_{d , l} [ {( {T}_{d , l} - {\hat{T}}_{d , l} )}^{2} + {λ}_{1} {\{ g ( \frac{\partial {\hat{T}}_{d , l}}{\partial d \partial l} ) \}}^{2} ] & ( Equation 31 )\end{matrix}$$

In Equation 31, the temperature corrected by the temperature correcting unit 322 is denoted by the symbol below where T_{d, l} denotes the temperature estimated by the temperature estimating unit 205.

### [Math. 37]

\hat{T}_{d,l}

Here, λ₁ and g are weighted functions. The weighted function g is, for example, a Huber function. Here, d denotes the spatial position in the depth direction, and l denotes the spatial position in the line direction.

In Equation 31, the first term is a term for approximating a temperature correction value to the estimated temperature value, and the second term is a term for calculating the space derivative of the estimated temperature value. The temperature correcting unit 322 calculates such a temperature correction value that minimizes the objective function f₁ shown as Equation 31 by performing a numerical calculation such as a conjugate gradient method. In this way, the temperatures estimated by the temperature estimating unit 205 can be corrected to the temperatures that are spatially continuous.

### Embodiment 3

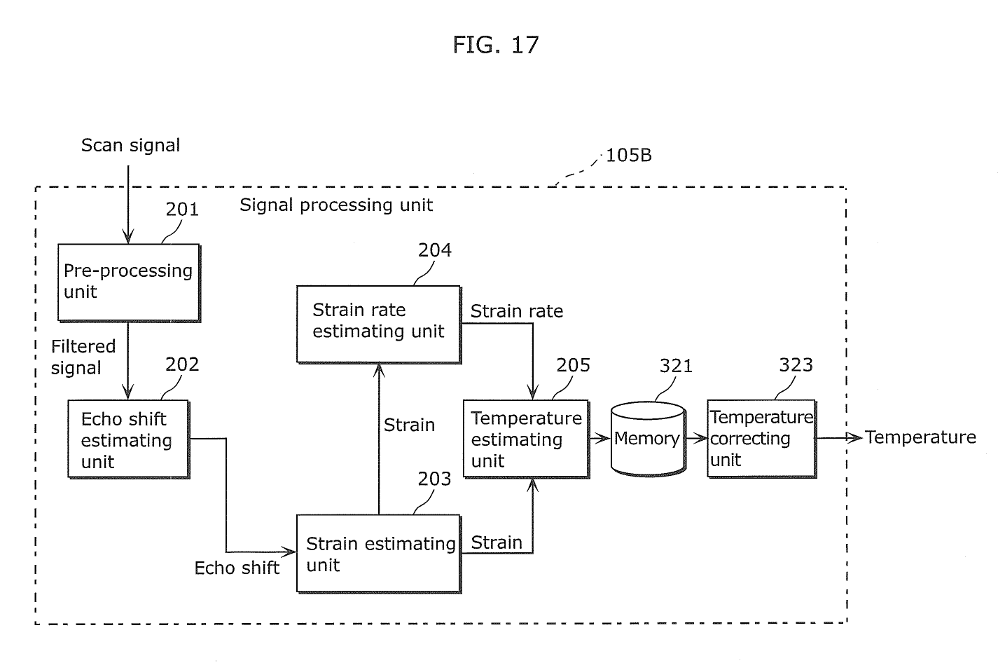

FIG. 17 is a block diagram of a structure of a temperature estimation apparatus according to Embodiment 3 of the present invention. A temperature estimation apparatus according to this embodiment includes a signal processing unit 105B that further includes a temperature correcting unit 323 in stead of the temperature correcting unit 322 in Embodiment 2. The temperature correcting unit 323 corrects the temperatures corresponding to one frame (or a plurality of frames) stored in the memory 321, based on an objective function f₂ considering the distance between the target region 51 and the position of a body area heated by the ultrasound signal for heating (a temperature correcting step). This temperature correcting step is executed after the aforementioned temperature estimating step.

The aforementioned objective function f₂ can be represented according to the equation shown below.

$$\begin{matrix} [ Math . 38 ] & \\ {f}_{2} = {\sum }_{d , l} [ {( {T}_{d , l} - {\hat{T}}_{d , l} )}^{2} + {{λ}_{2} [ ( {T}_{{d}_{0} , {l}_{0}} - {\hat{T}}_{d , l} ) - α {\{ {( {d}_{0} - d )}^{2} + {( {l}_{0} - l )}^{2} \}}^{\frac{3}{2}} ]}^{2} ] & ( Equation 32 )\end{matrix}$$

In Equation 32, λ₂, and α are weighted functions.

In Equation 32, the first term is a term for approximating a temperature correction value to the estimated temperature value, the second term is the difference between the temperature at the position (d₀, l₀) of the body area and the position (d, l) for which the temperature correction value should be calculated, and the third term is a term that is inversely proportional to the cube of the distance from the position of the body area. The temperature correcting unit 323 calculates such a temperature correction value that minimizes the objective function f₂ shown as Equation 32 by performing a numerical calculation such as a conjugate gradient method. In this way, the temperatures estimated by the temperature estimating unit 205 can be corrected to the temperatures according to the distance between the position of the body area and the target region.

It is to be note that each of the structural elements in each of the above-described embodiments may be configured in the form of an exclusive hardware product, or may be realized by executing a software program suitable for the structural element. Each of the structural elements may be realized by means of a program executing unit, such as a CPU and a processor, reading and executing the software program recorded on a recording medium such as a hard disk or a semiconductor memory. Here, the software program for realizing the temperature estimation method according to each of the embodiments is a program described below.

This program causes a computer to execute: receiving a scan signal generated by scanning the target region using the ultrasound signal, and estimating, based on the scan signal, an echo shift which is an amount of change in time required for the ultrasound signal to pass through the target region, the time changing depending on the temperature in the target region; estimating, based on the estimated echo shift, a strain which is an apparent change rate of a travel distance required for the ultrasound signal to pass through the target region, the travel distance changing depending on the temperature in the target region; estimating, based on the estimated strain, a strain rate which is a temporal change rate of the strain; and estimating the temperature in the target region corresponding to the strain and the strain rate, based on a predetermined relationship between a strain, a strain rate, and a temperature.

Furthermore, the program may be recorded on computer-readable non-volatile recording media such as a flexible disc, a hard disk, a CD-ROM, an MO, a DVD, a DVD-ROM, a DVD-RAM, a BD (Blu-ray Disc (registered trademark)), and a semiconductor memory.

The temperature estimation methods, temperature estimation apparatuses, and program according to one or more aspects of the present invention have been described above based on Embodiments 1 to 3. However, the present invention is not limited to Embodiments 1 to 3. The one or more aspects of the present invention may include various modifications to these exemplary embodiments and/or other embodiments having arbitrarily combined structural elements of different embodiments which may be conceived without materially departing from the principles and spirit of the present invention.

### INDUSTRIAL APPLICABILITY

The present invention is applicable as temperature estimation methods, temperature estimation apparatuses, and programs that make it possible to estimate temperatures with high accuracy in wide temperature ranges.

### REFERENCE SIGNS LIST

10 Temperature estimation apparatus
50 Living subject
51 Target region
101 Main body
   102 Ultrasound transducer
103 Transmitting unit
104 Receiving unit
105, 105A, 105B Signal processing unit
106 Display unit
107 Control unit
201 Pre-processing unit
202 Echo shift estimating unit
203 Strain estimating unit
204 Strain rate estimating unit
205 Temperature estimating unit
301 Corrupted frame removing unit
302 Noise filter
303 Echo shift calculating unit
304 Outlier correcting unit
305 Echo shift noise filter
306 Strain calculating unit
307 Strain noise filter
308 Strain rate calculating unit
309 Strain rate noise filter
310 Parameter calculating unit
311 Temperature calculating unit
321 Memory
322, 323 Temperature correcting unit

1. A temperature estimation method of estimating a temperature in a target region using an ultrasound signal, the temperature estimation method comprising:
receiving a scan signal generated by scanning the target region using the ultrasound signal, and estimating, based on the scan signal, an echo shift which is an amount of change in time required for the ultrasound signal to pass through the target region, the time changing depending on the temperature in the target region;
estimating, based on the estimated echo shift, a strain which is an apparent change rate of a travel distance required for the ultrasound signal to pass through the target region, the travel distance changing depending on the temperature in the target region;
estimating, based on the estimated strain, a strain rate which is a temporal change rate of the strain; and
estimating the temperature in the target region corresponding to the strain and the strain rate, based on a predetermined relationship between a strain, a strain rate, and a temperature.

2. The temperature estimation method according to claim 1,
wherein, in the estimating of a temperature, the temperature in the target region corresponding to the strain and the strain rate is estimated according to a linear model equation showing the relationship between the strain, the strain rate, and the temperature.

3. The temperature estimation method according to claim 1, further comprising
removing, as pre-processing, a frame corrupted by disturbance from the scan signal,
wherein, in the estimating of an echo shift, the echo shift is estimated based on the scan signal from which the corrupted frame is already removed in the removing.

4. The temperature estimation method according to claim 1,
wherein the estimating of an echo shift further includes:
calculating a raw echo shift based on the received scan signal;
correcting an outlier that is not caused by a temperature change in the calculated raw echo shift to generate an echo shift that is caused by a temperature change; and
attenuating, using a noise filter, noise included in the echo shift caused by the temperature change.

5. The temperature estimation method according to claim 4,
wherein the correcting of an outlier includes:
adjusting a parameter in an echo shift prediction model for calculating a predicted echo shift, based on the raw echo shift calculated in the calculating of an echo shift;
calculating the predicted echo shift based on the echo shift prediction model that is optimized;
setting one or more threshold values, based on the predicted echo shift and an RF signal that is generated by scanning the target region; and
correcting a data point that is included in a plurality of data points of the raw echo shift and is the outlier exceeding the one or more threshold values to fit a data point corresponding to the predicted echo shift.

6. The temperature estimation method according to claim 5,
wherein the echo shift prediction model is an error function or a complementary error function.

7. The temperature estimation method according to claim 5,
wherein the setting of a threshold value includes:
setting a gap between an upper threshold value and a lower threshold value as the one or more threshold values; and
adjusting the upper threshold value and the lower threshold value by using, as a weight, intensity of the RF signal.

8. The temperature estimation method according to claim 1,
wherein, in the estimating of a strain rate, the strain rate is estimated using a model equation for predicting the echo shift based on a depth and a product of the depth and time of the scan signal in such a manner that an error between the echo shift estimated based on the scan signal and the echo shift predicted according to the model equation is minimized.

9. The temperature estimation method according to claim 8,
wherein the model equation used in the estimating of a strain rate is a linear model equation.

10. The temperature estimation method according to claim 2,
wherein an algorithm parameter in the linear model equation used in the estimating of a temperature is identified by:
aligning a thermocouple with the target region to be heated;
measuring the temperature in the target region using the thermocouple;
deriving the estimated temperature in the target region, based on the scan signal generated by scanning the target region; and
identifying the algorithm parameter that minimizes an error between the temperature measured in the measuring of the temperature and the estimated temperature derived in the deriving of the estimated temperature.

11. The temperature estimation method according to claim 10,
wherein the aligning includes:
aligning the thermocouple with the target region to be heated, using a B-mode image;
turning ON a heat source that outputs an ultrasound signal to change the temperature in the target region;
performing iterations of (i) shifting the heat source in a space and (ii) measuring a temperature in the target region using the thermocouple; and
stopping the shifting of the heat source when a temperature measured using the thermocouple reaches a minimum.

12. The temperature estimation method according to claim 1, further comprising
correcting the temperature estimated in the estimating of a temperature, based on an objective function considering spatial continuity of temperatures.

13. The temperature estimation method according to claim 1, further comprising
correcting the temperature estimated in the estimating of a temperature, based on an objective function considering a distance between the target region and a position of a body area heated by an ultrasound signal for heating.

14. A temperature estimation device which estimates a temperature in a target region using an ultrasound signal, the temperature estimation device comprising:
an echo shift estimating unit configured to receive a scan signal generated by scanning the target region using the ultrasound signal, and estimate, based on the scan signal, an echo shift which is an amount of change in time required for the ultrasound signal to pass through the target region, the time changing depending on the temperature in the target region;
a strain estimating unit configured to estimate, based on the estimated echo shift, a strain which is an apparent change rate of a travel distance required for the ultrasound signal to pass through the target region, the travel distance changing depending on the temperature in the target region;
a strain rate estimating unit configured to estimate, based on the estimated strain, a strain rate which is a temporal change rate of the strain; and
a temperature estimating unit configured to estimate the temperature in the target region corresponding to the strain and the strain rate, based on a predetermined relationship between a strain, a strain rate, and a temperature.

15. A non-transitory computer-readable recording medium having a program recorded thereon for estimating a temperature in a target region using an ultrasound signal, the program causing a computer to execute:
receiving a scan signal generated by scanning the target region using the ultrasound signal, and estimating, based on the scan signal, an echo shift which is an amount of change in time required for the ultrasound signal to pass through the target region, the time changing depending on the temperature in the target region;
estimating, based on the estimated echo shift, a strain which is an apparent change rate of a travel distance required for the ultrasound signal to pass through the target region, the travel distance changing depending on the temperature in the target region;
estimating, based on the estimated strain, a strain rate which is a temporal change rate of the strain; and
estimating the temperature in the target region corresponding to the strain and the strain rate, based on a predetermined relationship between a strain, a strain rate, and a temperature.
